(19) United States
(12) Patent Application Publication
(10) Pub. No.: US 2021/0019708 A1
(43) Pub. Date: Jan. 21, 2021

(54) Method and system for evaluating the cultural fit of a person and a workplace based on level of interest

(71) Applicants: ILEANA RIZESCU, Calabasas, CA (US); MARK ALLEN MALLINGER, Malibu, CA (US)

(72) Inventors: ILEANA RIZESCU, Calabasas, CA (US); MARK ALLEN MALLINGER, Malibu, CA (US)

(21) Appl. No.: 16/947,656

(22) Filed: Oct. 13, 2020

(51) Int. Cl. G06Q 10/10; G06F 16/9035; G06F 16/951; G09B 7/00

(52) U.S. Cl. CPC G06Q 10/1053; G09B 7/00; G06F 16/951; G06F 16/9035

(57) ABSTRACT

A method and a system for evaluating the cultural fit of a person and a workplace based on assessing, analyzing and interpreting a set of characteristics of a workplace culture, a set of work personality characteristics of the person, and degrees of interest. The characteristics of the workplace culture are correlated with the personality traits on levels of comparisons and the degree of interest of having a cultural fit is evaluated on each level of comparison. The web-based system is an assembly of online tools for collecting assessment data and calculating different data analysis indices using a proprietary algorithm. At the end of data collection and analysis processes, the user is offered a comprehensive set of interpretations of how the workplace culture and the individual personality are harmonizing together.

### CROSS-REFERENCE TO RELATED APPLICATION

This application claims the benefit of U.S. Provisional Application No. 62/885,703 filed on Aug. 12, 2019, the specification of which is hereby incorporated herein by reference.

### BACKGROUND OF THE INVENTION

### Statement of the Problem

Much of the adult life, people relate with workplaces as employees, prospective employees, or workplace leaders, their interaction being extensive, complex, and with repercussions for both the person and the workplace. Consequently, it is very important to analyze and understand this relationship between a person and a workplace, which has many aspects, some of them intangible, beyond the fit between a job description and a resume or a set of skills. The authors of this invention have identified that some of these aspects are due to particularities of the business culture of an employer (herein referred to as a workplace) and the work personality of an employee or prospective employee.

For the purposes of this patent description, the workplace culture is defined as the underlying beliefs, values, and ways of interacting that are aggregated into a unique social and psychological environment of the workplace. The work personality characteristics are defined as those personality traits that are directly related to the work environment and on-the-job behaviors. Workplace culture influences and determines changes in employees' lives, as well as employees may determine changes in the workplace culture and the general work atmosphere. For example, an organizational culture can foster the development of certain personality traits of an employee, or it can stifle the expression of other personality aspects, thus having a positive or negative impact on their life. Also, an employee who does not integrate in or agree with the workplace culture may act against it causing disturbances in the work atmosphere, even if they bring a great deal of skill and experience to their craft.

Although a good cultural fit offers a comfortable basis for communication and collaboration, it is not always favorable to one of the parties. A misfit denotes dissimilarities that may contain potential opportunities for growth through the adaptive and creative efforts to overcome the differences. For example, a more traditional company, focused on perpetuating what worked in the past, may find itself unable to respond to unexpected events in the environment. Once it had identified the need to change its course of business accordingly to new market challenges, the company may want to hire individuals who are not a good fit with the traditional culture and have a present and future-minded, dynamic personalities.

The invention described herein has identified that the intentions of a company or individual, expressed as a level of interest in having a cultural fit or misfit on certain characteristics of the other party, are also important factors in evaluating the dynamics of their relationship. For example, a company engaged in exploratory activities would be very interested in hiring risk-taking, adaptive individuals, although other personality traits may not be so well aligned with some characteristics of the company culture. In another example, if an individual has the personality of a follower and wants to develop own leadership capabilities, then they will value the growth opportunities offered by a weak sync with an organization that stimulates its members' leadership and their ability to influence the business processes.

In the context described above, the invention is based on the recognition and understanding that the way the individual work personality weaves into a workplace culture represents an invisible fabric which supports, enhances, or hinders job-related activities, as well as the evolution of the employee personality, therefore it is consequential to be measured and understood. The invention also factors in that a certain level of interest expressed by one of the parties places a significant weight in the overall evaluation of the cultural fit/misfit, offering interpretations that show the compatibilities, growth opportunities, and a prognostic of the evolution of the relationship.

### Description of the Related Art

There are no known methods or systems to compare a workplace culture and the work personality of an individual that quantifies and analyzes the level of fit between them based on the level of interest of either party involved in the relationship, offering interpretations that show the compatibilities, growth opportunities, and a prognostic of the relationship evolution.

In one undertaking to evaluate the culture of a company, described in U.S. Pat. No. 10,445,668, a system analyzes a multitude of characteristics of a company, including culture, and predicts future behavior of the organization. The system aggregates employee information including personal aspects into an evaluation of the company.

Another undertaking to evaluate company profile is described in U.S. Pat. No. 8,346,569 as a system and method for dynamically generating a customized profile for a company for a selected profile type, such as an employment profile. In creating a company profile, the system includes cultural aspects and aggregates personal profiles of the members to produce the company profile. While recognizing the importance of personality aspects of employees in the overall makeup of the company, the above-mentioned patents are not focused on evaluating the particular aspects of the relationship between the company and an employee or a prospective employee. They also do not consider the level of interest the organization or the individual may have in particular aspects of their relationship with the other party, which plays an important role in the selection or continuation of the relationship. The present invention factors in the weight the interest on a particular sync places in the overall evaluation of the relationship between a workplace and an individual.

For evaluating the culture of a workplace, one embodiment of the invention described in this document is using an updated version of the Integrated Cultural Framework, which is the result of many years of research of the inventors, mentioned in their writings referenced herein. This embodiment is also using a set of work personality characteristics specifically created by the inventors to be congruent with the workplace culture characteristics of the updated Integrated Cultural Framework.

Human personality has been a subject of research and classifications for many years, and more recently there is a focus on analyzing work personality. The Work Personality Index® (WPI) evaluates the traits that are important in the work environment with the intention to facilitate the hiring process. In a human-led consulting process, a set of benchmarks is created by an employer for a specific job for which they analyze the candidates using WPI. This process generates a Job Match Report which will indicate how well the individual's personality traits match with the requirements of the job. The process does not evaluate the cultural characteristics of the workplace to compare them with the work personality characteristics, therefore, while assessing the fit with the job, it does not capture and interpret the aspects that may not be a good fit with the overall culture of the workplace. As an example of such a situation, a company is a congregation-lead workplace that supports its members, therefore it is a low egalitarian institution. This company can hire a person who is very fit for a particular job, but because that person does not belong to the congregation, therefore does not have a cultural fit on this dimension with the company, this individual's chances for recognition and promotion are reduced or non-existent.

Another endeavor to find the matching candidates for employment with a company and automate the hiring process is described in U.S. Pat. No. 7,212,985 B2 as a system and method for automatically managing and carrying out the process in which human shoppers may seek out, select and/or be matched with other human entities for any purpose. It embodies a comprehensive, iterative scoring system appropriate for an automated selection process including quantifiable measures as well as verification and reference checking steps. These processes result in selected or not selected human entities and do not offer an analysis of a possible relationship between the two human entities.

The invention described herein offers a vision of the relationship between a company and an employee that raises above the fit/misfit or match/not match paradigms, by offering to the user a set of detailed interpretations that reveal both potential advantages and challenges of fit situations as well as of low fit or misfit situations. It recognizes that there are growth opportunities in cultural differences between the workplace and the individual that may be beneficial for either party.

### BRIEF SUMMARY OF THE INVENTION

This invention brings an innovative method and a system to correlate, quantify, analyze and interpret the interactional aspects between the culture of a workplace and an individual's work personality based on one's level of interest. This invention provides a coherent assembly of tools to be used by employees or prospective employees, as well as by employers or their consultants, to evaluate the cultural fit (herein referred also as sync) between a workplace culture and an individual personality. Such an evaluation is valuable to all parties involved in any decision process relative to new employment or continued employment.

This method and system are designed to be relatively independent of the economic and social environment in which the workplace and the individual are located, as well as independent of the demographic characteristics of the users. As a result, this method and system are portable across countries and generations of employable or employed individuals.

### BRIEF DESCRIPTION OF THE DRAWINGS

FIG. 1 is a flowchart illustrating the steps in which the tools provided by this invention can be used by an individual (employee, prospective employee, candidate, ex-employee) to evaluate their cultural fit with a workplace based on his/her level of interest. This embodiment can be used by an individual (employee, prospective employee, candidate, ex-employee) to evaluate their cultural fit with a workplace based on their level of interest. In the first step of the process flow, numbered 1, the user goes through the Workplace culture evaluation process, after which the evaluation results obtained for each of the n cultural characteristic C1, . . . Cn are stored in Workplace Cultural Profile Database. In the second step of the process flow, numbered 2, the user undertakes the Individual work personality evaluation along the n personality characteristics P1, . . . Pn. In the third step of the process flow, numbered 3, the user assesses his/her degree of interest in having a sync on each of the n levels of comparison that associate a company culture characteristic Ci with the corresponding work personality Pi, i=1 . . . n. The results obtained from the above three steps are processed by the Algorithm for calculating and interpreting the degree of cultural fit/sync. After calculations, the algorithm accesses the Analysis, Interpretations & Conclusions Database, extracts from it the Customized Analysis, Interpretations and Conclusion corresponding to the calculated specific values, and delivers them to the user.

FIG. 2 is a flowchart illustrating another embodiment of this invention, in which the tools include also the Workplace Cultural Profile database. This embodiment can be used by an individual (employee, prospective employee, candidate, ex-employee) to evaluate their cultural fit with a workplace based on their level of interest. In the first step of the process flow, numbered 1, the user has the option to search in the Workplace Cultural Profile Database to find the cultural profile of his/her workplace. If the profile was found and agreed to, then the user goes to the second step, numbered 2; otherwise the user goes through the Workplace culture evaluation process, after which the evaluation results obtained for each of the n cultural characteristic C1, . . . Cn are stored in Workplace Cultural Profile Database. In the second step of the process flow, numbered 2, the user undertakes the Individual work personality evaluation along the n personality characteristics P1, . . . Pn. In the third step of the process flow, numbered 3, the user assesses his/her degree of interest in having a sync on each of the n levels of comparison that associate a company culture characteristic Ci with the corresponding work personality Pi, i=1 . . . n. The results obtained from the above three steps are processed by the Algorithm for calculating and interpreting the degree of cultural fit/sync. After calculations, the algorithm accesses the Analysis, Interpretations & Conclusions Database, extracts from it the set of Customized analysis, interpretations and conclusion, and delivers it to the user.

FIG. 3 is a flowchart illustrating another embodiment of this invention, in which the tools provided by this invention can be used by an employer (hiring manager, HR responsible, recruiter, head-hunter) to evaluate the cultural fit between a workplace and an existing or prospective employee based on workplace's level of interest. In the first step of the processing flow, numbered 1, the employer evaluates the Workplace Culture or retrieves, from the Workplace Cultural Profile Database, a previously evaluated cultural profile of the workplace. In the second step, numbered 2, the existing or prospective employee undertakes the Individual work personality evaluation along the n personality characteristics P1, . . . Pn. In the third step of the process flow, numbered 3, the employer assesses his/her company's degree of interest in having a sync on each of the n levels of comparison that associate a company culture characteristic Ci with the corresponding work personality Pi, i=1 . . . n. The results obtained from the above three steps are processed by the Algorithm for calculating and interpreting the degree of cultural fit/sync. The algorithm accesses the Analysis, Interpretations & Conclusions Database, extracts from it the set of Customized Analysis, Interpretations and Conclusion, and delivers it to the employer.

FIG. 4 illustrates the main components of the web-based system that implements the method of the preferred embodiment of this invention. This web-based system has two main sections: the User Interface and the Data and Algorithms. The User Interface is composed of Static Webpages (their content is not changing) and Interactive Webpages (they require user's input and their content is changing based on user's input). The Data and Algorithms section is composed of Static Data (which is predefined for each embodiment of this invention), Dynamic Data (which is changing dependent on users input and on accumulation of data over the time), and Algorithms (which incorporate, for each embodiment of this invention, the logic of quantifying, calculating and retrieving the interpretations, as well as the logic of retrieving an already stored cultural profile). FIG. 4 also illustrates how these components intervene in the process flow. Through the Internet, the user is interfaced with static webpages which provide information about the website and about the evaluation of the cultural fit of a person and a workplace. Then the user is invited to interact with the system by creating a user profile (stored in the Dynamic Data). Then the user is offered the possibility to search the Dynamic Database of Workplace Cultural Profiles and is invited to answer three questionnaires. The questionnaires access the Static Data to display the questions and then store the results in the Dynamic Data section of the system. Then the algorithms, based on the existing static data and the dynamic data collected from the user, perform calculations and store some results in the dynamic database of Workplace Cultural Profiles. At user request, an algorithm retrieves and assesses the cultural profile for a workplace. The algorithms are also employed for quantifying and finding personalized analysis and interpretation and the overall conclusion.

### DETAILED DESCRIPTION

This invention is comprised of a method and a system for evaluating how an individual's personality fits with or harmonizes with a workplace culture based on:
n characteristics of workplace culture (C1, C2, . . . Cn);
n characteristics of individual work personality (P1, P2, . . . Pn) that are congruent with the characteristics of the workplace culture;
n levels of comparison between workplace culture and the work personality of an individual, each level comparing a workplace culture characteristic and a related personality characteristic;
n evaluations of the degree of interest corresponding to each of the n levels of comparison;
a database of analysis and interpretations items wherein each item of analysis and interpretation corresponds uniquely to one of all possible combinations of values measured for the four elements enumerated above elements; this database contains also the final conclusions;
a web-based system that collects online the evaluation data from a user, stores and processes it, and delivers the corresponding interpretations to the user.

In a preferred embodiment of this invention, a user of this invention has to answer 3 online questionnaires:
1. The first questionnaire evaluating workplace culture on n characteristics, C1, C2, . . . , Cn and associating numeric values for each characteristic c1, c2, . . . cn;
2. The second questionnaire evaluating the individual personality on n characteristics, P1, P2, . . . , Pn and associating numeric values for each characteristic p1, p2, . . . pn;
3. The questionnaire measuring the user's level of interest in having a sync on each of the n levels of comparison and associating numeric values for the level of interest on each level, I1, I2, . . . In;

For each of the first two questionnaires, there is the same given number of questions dedicated to each characteristic, all the questions being shuffled into the total set of questions that the user has to answer. The numbers associated with the responses to the questions targeting a certain workplace culture characteristic, for example Ci (where i=1 to n), are then averaged to obtain a numeric value ci for that characteristic. The numbers associated with the responses to the questions targeting a certain work personality characteristic, for example Pi (where i=1 to n), are then averaged to obtain a numeric value pi for that characteristic.

The workplace culture characteristics and the work personality characteristics are correlated on n levels of comparison, where each of the n characteristics of the workplace culture is exclusively associated with one of the n personality characteristics. The correlation is such so that the first level of comparison associates the first workplace culture characteristic C1 with the correspondingly congruent characteristic of the individual's personality, say P1, and so on, to the n-th level of comparison which associates the n-th workplace culture characteristic Cn with the n-th characteristic of the individual's personality Pn.

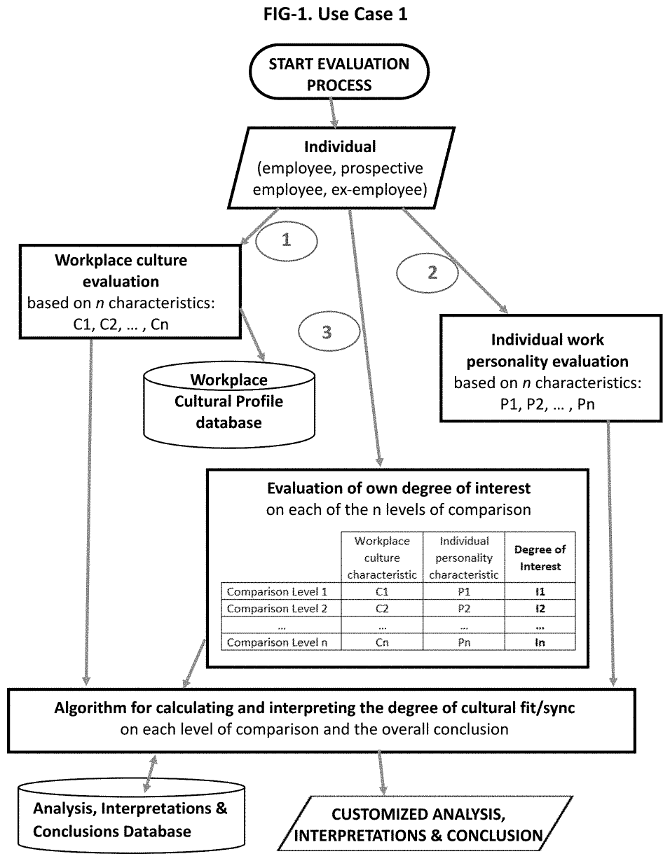

In the third questionnaire, the user is asked to assess the level of interest in having a cultural fit (or a sync) between the workplace culture characteristic and the work personality characteristic on each level of comparison from 1 to n (see FIG. 1 for a graphic representation of the third questionnaire).

After the user has finished answering all three online questionnaires, an algorithm performs the following functions:
a) quantifies the evaluations obtained from the workplace culture questionnaire and the work personality questionnaire using the same scale and method of quantification, resulting in assigning one score values to each of them; the score value signifies the level to which that characteristic is manifested, such as “Low”, “Medium”, “High”;
b) calculates the degree of fit or sync on each of the n levels of comparison as the gap between the numeric values obtained for the workplace culture characteristic and work personality characteristic correlated on the same level of comparison, so for the level of comparison i, where i=1 to n, then sync(i)=|ci−pi|;
c) calculates the overall degree of sync between the company culture and work personality as AVERAGE (sync(i)) where i=1 to n;
d) calculates the weighted average of the overall sync, where each level of comparison's sync value is weighted with the number associated to the degree of interest measured for that level of comparison using the third questionnaire: SUM(Ii×sync(i))/SUM(Ii) where i=1 to n;
e) calculates the keys to access a database of items of analysis and interpretation; the database contains one set of items of analysis and interpretation for each possible combinations of values calculated at a), b) and c) steps of the algorithm
f) calculates the key to access the conclusion of the interpretation based on the values obtained from the b), c) and d) steps of the algorithm
g) based on all previously enumerated calculations, the algorithm retrieves the corresponding items of analysis and interpretation and the user is provided with
   a. an analysis and an interpretation on each of the n levels of comparison along the following three dimensions:
      Compatibility (based on what is in sync and what is not)
      Growth Opportunities (what is to learn from dissimilarities and how to evolve in this situation) as well as Challenges
      Convergence—a forecast of possible future developments based on the level of interest and level of sync
   b. An overall conclusion of all the analysis and interpretation items

Beyond diagnosing a fit/misfit situation, the analysis and interpretation are meant to also guide a user in identifying and evaluating the possibilities for communication and evolution within the workplace environment, so they can understand and make the best of their relationship with the particular workplace.

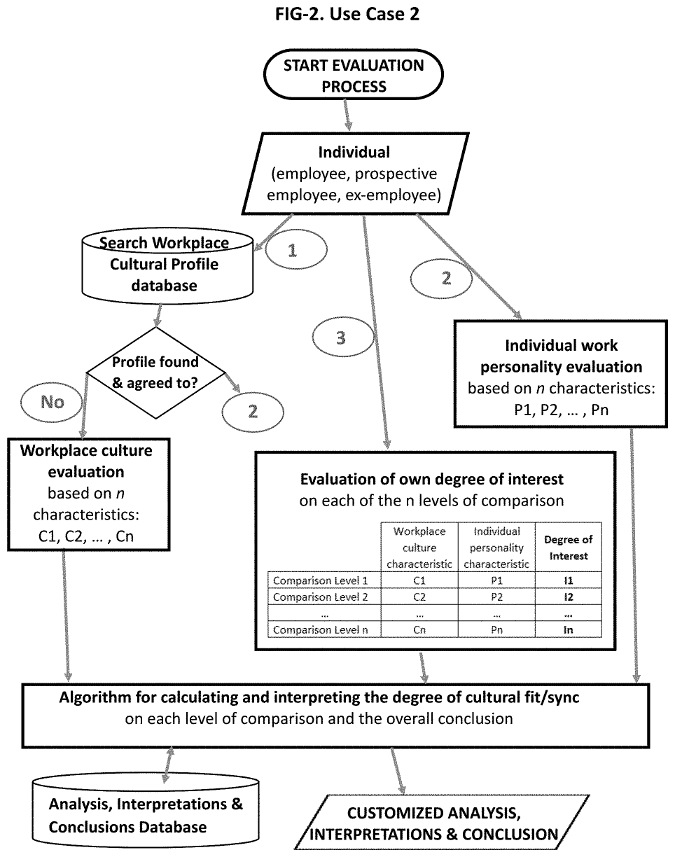

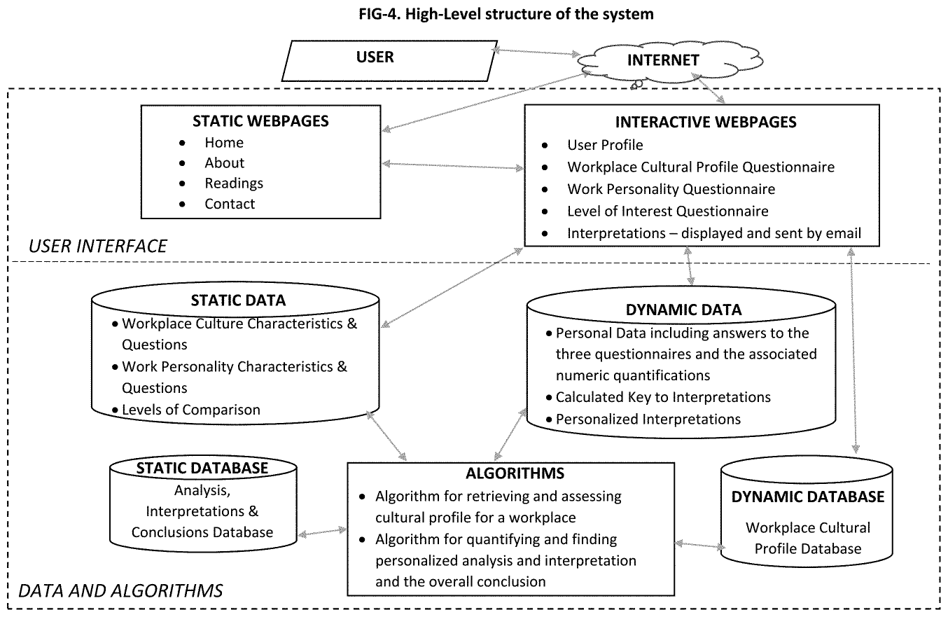

The method is implemented through a web-based system with the main components represented in FIG. 4. These components of the system are:
The User Interface is composed of:
   Static Webpages which are predefined for a particular embodiment of this invention and provide information about the method and the system, and
   Interactive Webpages which require user input and exchange data with the system's databases and algorithms.
The Static Data is predefined for each embodiment of this invention and is composed of:
   Workplace Culture Characteristics & Questions,
   Work Personality Characteristics & Questions,
   Levels of Comparison,
   Analysis, Interpretations & Conclusions Database.
The Dynamic Data is evolving during the interaction between the system and the users and it is composed of:
Personal Data of the user including the answers to the three questionnaires and the associated numeric quantifications,
Calculated Key to Interpretations specific to the user,
The personalized set of items of analysis, interpretations and conclusion, items which are specific to the user and are extracted from the Analysis, Interpretations & Conclusions Database,
Workplace Cultural Profile Database which stores all the cultural evaluations of different workplaces selected by all the users of this system over time;
The Algorithms which are predefined in terms of logic and programming with the following functions:
   quantifying and finding personalized analysis and interpretation as well as the overall conclusion
   retrieving and assessing cultural profile for a workplace using the Workplace Cultural Profile Database; this function is employed in the embodiment of this invention described below and represented in FIG. 2.

In the beginning, the user is required to enter minimal personal information about himself/herself and the company or workplace on which they are focusing. In the next steps of the process, the Interactive Webpages extract static data and display the characteristics of workplace culture with their corresponding questions, then the personality characteristics along with their corresponding questions, the user having to rate each question. Then the user is presented with the third questionnaire for evaluating the level of interest in having a match on each of the comparison levels. As the user completes all of the three questionnaires, the interactive webpages are storing answers to the questions in the dynamic data section of the system, organizing them in Workplace Cultural Profile data, individual personality profile data, and level of interest data. The user can choose to interrupt answering the three questionnaires at any time and return later to resume work based on personal credentials established in the beginning. At the end, the system is running a proprietary coded algorithm, calculates the keys, and accesses the Analysis, Interpretations & Conclusions Database and displays, as well as emails, a report containing the analysis and interpretation items along with the specific overall conclusion corresponding to responses collected with the three questionnaires.

Because the system configuration has separated the static and dynamic or variable system elements and parametrized some of the key variables, the system is easily configurable for being used in different languages and for the different embodiments presented below.

In one embodiment of this invention, represented in FIG. 1, the user is an existing employee, a prospective employee, or an ex-employee who has knowledge about the workplace culture. The user completes the first questionnaire about the workplace culture and his/her answers get quantified and averaged for each of the n characteristics. The computed workplace culture results will be used along with the results from the next questionnaires, and they also get stored in the Workplace Cultural Profile database. Then the user completes the second questionnaire about his/her personality and his/her answers get quantified and averaged for each of the n personality traits. In the next step, the user answers the third questionnaire, and for each of the comparison levels, he/she is rating his/her level of interest in having a match with the workplace on that level of comparison. The results from the three questionnaires are processed through the proprietary algorithm which calculates, aggregates the numeric results, forms the keys, and selects the appropriate set of analysis and interpretation items. At the end, the user is provided with an analysis on each level of comparison and also with an overall evaluation of the degree of harmonization between him/her and the workplace.

Under the same scenario described above, a particular embodiment is using n=7 and the following 7 characteristics for analyzing the workplace culture in this order: 1) Ability to Influence, 2) Comfort with Ambiguity, 3) Achievement Orientation, 4) Individualism versus Collectivism, 5) Time Perspective, 6) Equal Opportunity and 7) Connectedness. These characteristics are correlated with the following 7 personality characteristics: 1) Leadership, 2) Adaptability, 3) Achievement Oriented, 4) Individualism versus Communitarian Spirit, 5) Progressive, 6) Egalitarian, and 7) Communicative and Sociable. The 7 levels of comparison are associating the Ability to Influence of the workplace with the Leadership personality characteristic, the Comfort with Ambiguity of the workplace with Adaptability of the individual, and so on to the seventh level of comparison between the Connectedness characteristic of the workplace associated with the Communicative and Sociable characteristic of the individual. The user answers the three questionnaires and the system generates the analysis, interpretation, and conclusion items specific to the user's responses. In this embodiment of the invention, the Analysis, Interpretations & Conclusions Database is predefined and personalized to the characteristics enumerated at the beginning of this embodiment's description.

Another embodiment of the present invention is represented in FIG. 2, in which the user is an existing or prospective employee who doesn't have knowledge about the workplace or who wants to search the Workplace Cultural Profile Database to find the cultural profile of the workplace. If there are several query results for the same workplace, the evaluation values ci where i=1 to n for each cultural characteristic of each retrieved record are averaged for each cultural characteristic: ci=AVERAGE (ci(j)) where i=1 to n and j=1 to m, m being the number of the database records found for the same workplace. Then the set of averaged values is combined with the user's work personality scores to evaluate the user's degree of interest. If the user finds the cultural profile of the workplace and agrees with the averaged evaluations of its cultural characteristics, then these numeric values of the workplace cultural profile will be used in the algorithm for calculating and retrieving corresponding interpretations. If the user doesn't find the cultural profile of the workplace or doesn't agree to it, then the user can use external sources of information about the workplace and answer the first questionnaire about workplace culture. Then results from the workplace culture questionnaire will get stored in the Workplace Cultural Profile database and they will be used along with the results from the next two questionnaires for the final evaluation. In the following steps, the user answers the questionnaire about his/her personality and then rates his/her level of interest in a sync for each level of comparison. After processing the results from the workplace cultural profile and of the next two questionnaires, the user is provided with the customized analysis and interpretation on each level of comparison, as well as with the overall evaluation of the degree of harmonization between him/her and the workplace.

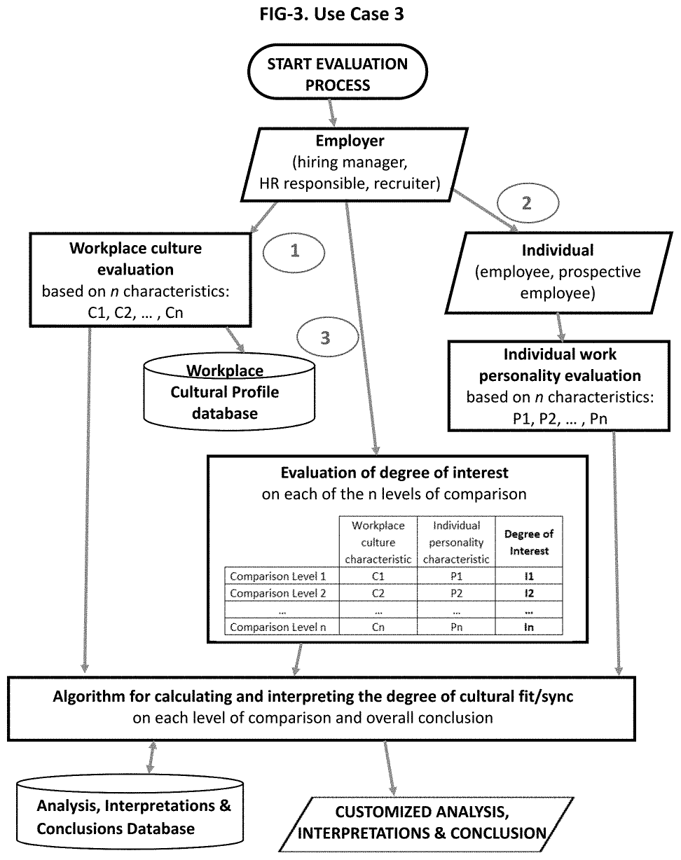

In another embodiment of this invention, represented in FIG. 3, the user is a hiring manager, a Human Resources responsible, or a recruiter. It is assumed that this user has knowledge about the employing workplace, so he/she completes the first questionnaire about the workplace culture and the answers get quantified and averaged for each of the n characteristics. If the user wants to use a previously stored cultural profile evaluation, they can access Workplace Cultural Profile database. The workplace culture questionnaire results get stored in the Workplace Cultural Profile database and are used along with the results of the next questionnaires. In the consequent step, the hiring manager or recruiter asks the employee (or prospective employee) to complete the questionnaire about his/her personality. Then the hiring manager answers the third questionnaire to rate the workplace's level of interest in having a cultural fit (or sync) with the employee or prospective employee. At the end, the hiring manager uses the system-generated interpretation as another deciding factor for hiring the prospective employee or for evaluating the current employment.

While preferred embodiments of the present invention have been shown in the drawings and described above, it will be apparent to one skilled in the art that various embodiments of the present invention are possible. For example, the number of characteristics used, the format and contents of the webpages, as well as the particular options made available to end-user viewers described herein should not be construed as limited to the specific embodiments described herein. Modification may be made to these and other specific elements of the invention without departing from its spirit and scope as expressed herein.

What is claimed is:

1. A method and a system involving a user in evaluating how an individual work personality fits (or is in sync) with a workplace culture comprising:
a set of a finite number n, of characteristics of a workplace culture,
a set of same finite number, said n, of work personality characteristics of an individual, where these characteristics are congruent with the said characteristics of a workplace culture,
a set of same number n of levels of comparison which correlate the said characteristics of a workplace culture with the said work personality characteristics, where each of the said characteristics of the workplace culture is exclusively associated to one of the said work personality characteristics,
an assessment tool to evaluate each of the said n characteristics for a particular workplace culture and calculate a numeric value for each of the said n cultural characteristics,
an assessment tool to evaluate each of the said n work personality characteristics of a particular individual workplace and calculate a numeric value for each of the said n personality characteristics
an assessment tool to evaluate the level of interest of a user in having a cultural fit on each of the said n levels of comparison and calculate a numeric value to the level of interest,
an algorithm with the following functions:
quantifying the evaluations obtained through the said assessment tools for said characteristics of a workplace culture and said work personality characteristics using the same scale and method of quantification, resulting in assigning one score values to each of them; the score value signifies the level to which that characteristic is manifested,
calculating, on each of the said n levels of comparison the degree of fit (or of sync) on that level of comparison as the gap between the numeric values obtained for the cultural characteristic and the work personality characteristic associated to each other on that level,
calculating the overall values of the analysis: the total average sync value and the total interest weighted average sync value,
calculating the index key values for finding the analysis and interpretation items corresponding to each of the said levels of comparison, as well as the index key value for finding the conclusion item,
a comprehensive set of analysis and interpretation items associated with every possible combination of the values calculated by the said algorithm, providing the user with the following elements:
the interpretation of the score obtained for each of the said characteristics of the workplace culture,
the interpretation of the score obtained for each of the said work personality characteristics,
the interpretation of the sync value for each of the said levels of comparison, describing the advantages deriving from similarities and the growth opportunities deriving from dissimilarities,
the interpretation of the level of interest in the context of the other scores obtained and a forecast of possible future developments based on the level of interest and level of sync,
the overall conclusion of the analysis and interpretation,
a web-based system implementing the functioning of the method with the said above elements, comprising
the online collection from a user of the evaluations for the said characteristics of the workplace culture, said personality characteristics, and said level of interest in having a sync on each said levels of comparison by using the said assessment tools,
the online processing of all the enumerated functions of the said algorithm,
an indexed database that stores all the said analysis and interpretation items associated with every possible combination of all the values calculated by the said algorithm,
an indexed database with user profiles,
an indexed database of Workplace Culture Profiles.

2. The method and system of claim 1, where
web-based questionnaires are replacing said assessment tools,
user's responses to these said questionnaire being numerically quantified
said algorithm calculating an average value for each characteristic and assigning a value signifying the level to which that characteristic is manifested in the workplace culture or individual personality.

3. The method and system of claim 1, where
said Workplace Culture Profiles database is obtained by recording and storing all the numeric evaluations and the score values associated with all cultural characteristics of each workplace assessed in the past by a user,
accessing and querying said Workplace Culture Profiles database by any other user of the system is replacing said assessment tool for evaluating the workplace culture characteristics.

4. The method and system of claim 2, where
said number n is 7,
said characteristics of the workplace culture are:
Ability to Influence,
Comfort with Ambiguity,
Achievement Orientation,
Individualism versus Collectivism,
Time Perspective,
Equal Opportunity and
Connectedness;
said personality characteristics are:
Leadership,
Adaptability,
Achievement Oriented,
Individualism versus Communitarian Spirit,
Progressive,
Egalitarian and
Communicative and Sociable;
said levels of comparisons are associating workplace culture characteristics with the work personality characteristics following the order in which they are enumerated above.
